(19) United States
(12) Patent Application Publication
(10) Pub. No.: US 2024/0349937 A1
(43) Pub. Date: Oct. 24, 2024

(54) COOKING TOOL

(71) Applicant: KYOCERA Corporation, Kyoto-shi, Kyoto (JP)

(72) Inventors: Takanori NISHIHARA, Takatsuki-shi, Osaka (JP); Masatoshi MACHIDA, Satsumasendai-shi, Kagoshima (JP)

(21) Appl. No.: 18/575,200

(22) PCT Filed: Jun. 29, 2022
(86) PCT No.: PCT/JP2022/026094

§ 371 Date: Dec. 28, 2023

(30) Foreign Application Priority Data
Jun. 30, 2021 (JP) 2021-109097

(51) Int. Cl. A47J 36/02; A47J 37/10

(52) U.S. Cl. CPC A47J 36/02; A47J 37/10

(57) ABSTRACT

A cooking tool includes a base member including a cooking region on one surface, and a coating film layer deposited on the one surface of the base member. The coating film layer includes a primer layer disposed on the base member side, a topcoat layer disposed on an outermost surface, and at least one intermediate layer disposed between the primer layer and the topcoat layer. The topcoat layer and the at least one intermediate layer are made of fluorine-based resin, and ceramic particles having different shapes are located across the topcoat layer and the at least one intermediate layer in a cross-sectional view.

### TECHNICAL FIELD

The present disclosure relates to a cooking tool such as a frying pan.

### BACKGROUND OF INVENTION

A known frying pan described, for example, in Patent Document 1 has been used as one type of cooking tool for heating and cooking food with heating. Such a frying pan is widely used at home or in restaurants and the like, and is made of metal materials. Cooking tools are known to be coated with a coating film containing fluorine-based resin in order to reduce adhesion or burning of food to the cooking tools.

A frying pan described, for example, in Patent Document 2, or the like is used. The frying pan includes fluorine-based resin film coated on a cooking region of a base member and containing particles consisting primarily of silicon carbide. Thus, abrasion resistance can be improved.

### CITATION LIST

### Patent Literature

Patent Document 1: JP 2012-200298 A

Patent Document 2: JP 2016-136990 A

### SUMMARY

A cooking tool of the present disclosure includes a base member including a cooking region on one surface, and a coating film layer deposited on the one surface of the base member. The coating film layer includes a primer layer disposed on the base member side, a topcoat layer disposed on an outermost surface, and at least one intermediate layer disposed between the primer layer and the topcoat layer. The topcoat layer and the at least one intermediate layer are made of fluorine-based resin, and ceramic particles having different shapes are located across the topcoat layer and the at least one intermediate layer in cross-sectional view.

### BRIEF DESCRIPTION OF THE DRAWINGS

FIG. 1A is a perspective view illustrating a cooking tool according to an embodiment of the present disclosure.

FIG. 1B is a cross-sectional view taken along a line X-X′ illustrated in FIG. 1A.

FIG. 2 is an enlarged cross-sectional view of a region Y illustrated in FIG. 1B.

FIG. 3 is an SEM (scanning electron microscope) photograph illustrating a cross section of one specific example of the cooking tool of the present disclosure.

FIG. 4 is an SEM photograph illustrating a part of FIG. 3.

FIG. 5 is an enlarged SEM photograph of one of the ceramic particles illustrated in the cross section in FIG. 4.

### DESCRIPTION OF EMBODIMENTS

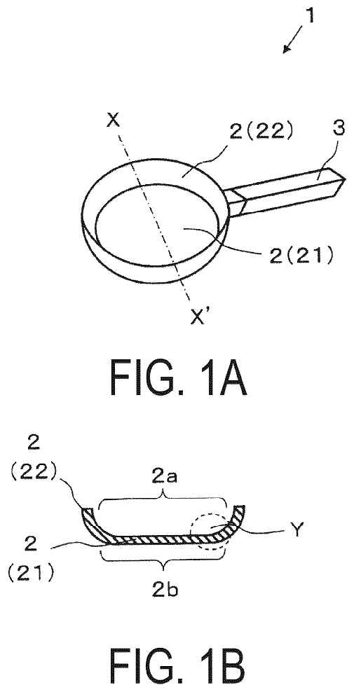

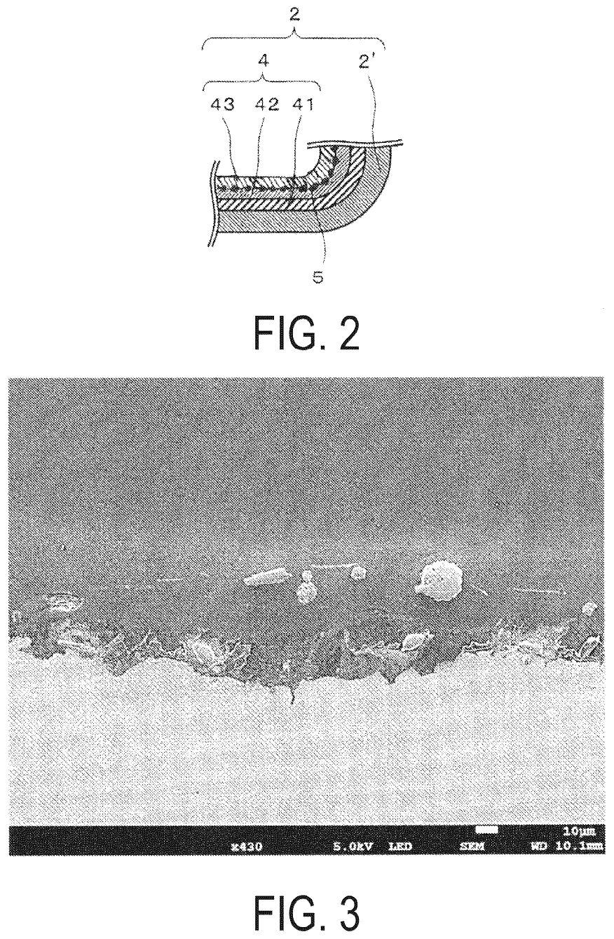

Hereinafter, a cooking tool according to an embodiment of the present disclosure will be described with reference to FIGS. 1 to 5. Among the drawings, FIGS. 1 and 2 are schematic drawings, and dimensions, ratios, and the like in the drawings do not always match the actual ones of the cooking tool.

The cooking tool according to the present embodiment will be described by taking a frying pan as an example as illustrated in FIG. 1A. A cooking tool 1 (frying pan) illustrated in FIG. 1A includes a body portion 2 and a handle 3. The body portion 2 includes a bottom portion 21 and a side surface portion 22. The body portion 2 is formed in a shallow container shape in the same way as or similarly to a known frying pan in which the side surface portion 22 is formed relatively low. The height from the bottom portion 21 to the top of the side surface portion 22, that is, the depth of the body portion 2 formed in a container shape is set as appropriate.

The shape of the body portion 2 is a circular shape, an elliptical shape, or a rectangular shape (including a shape in which corner portions are rounded) when viewed in plan view. The width of the body portion 2 is not limited and is set as appropriate.

The body portion 2 includes the bottom portion 21 and the side surface portion 22, and the side surface portion 22 is formed at a peripheral edge portion of the bottom portion 21 so as to surround the bottom portion 21. The side surface portion 22 may be formed perpendicular to the bottom portion 21, or may be formed at an obtuse angle with respect to the bottom portion 21 (that is, so as to be inclined outward from a lower portion to an upper portion of the side surface portion). The bottom portion 21 and the side surface portion 22 may be integrally formed, or may be separately formed and then joined to each other.

The handle 3 is a rod-shaped member and is attached to the side surface portion 22. The handle 3 is made of wood, resin, metal, or the like. Since the cooking tool 1 includes the handle 3, the cooking tool 1 can be easily handled during cooking. The handle 3 is not a member that is necessarily attached to the cooking tool 1. The handle 3 may be, for example, detachable.

As illustrated in the FIG. 1B, the body portion 2 includes a cooking region 2a and a heating region 2b. The cooking region 2a corresponds to a region surrounded by the side surface portion 22, and the heating region 2b corresponds to an outer surface of the bottom portion 21, that is, a region on the side opposite to the cooking region 2a. In the cooking region 2a, food materials are heated by heat applied to the heating region 2b. The heating region 2b is a region to which heat is applied by a gas cooking stove, an electric cooking stove, or an electromagnetic cooking device (IH cooking device). A metal material that improves heat conduction from the outside and reduces deformation of the cooking tool 1 may be attached to the heating region 2b. The metal material is not limited, and for example, a metal material different from a base member 2′ described below is preferably used. Specifically, a metal material having a thermal conductivity higher than that of the base member 2′, a material having a Young's modulus higher than that of the base member 2′, or the like is used.

In FIG. 1B, the body portion 2 (the bottom portion 21 and the side surface portion 22) is illustrated as having a single-layer structure. However, the body portion 2 has a multilayer structure. The structure will be specifically described based on FIG. 2. FIG. 2 is an enlarged cross-sectional view of a region Y illustrated in FIG. 1(B). As illustrated in FIG. 2, the body portion 2 includes the base member 2′ and a coating film layer 4.

The base member 2′ is made of a material primarily consisting of a metal. The metal is not particularly limited, and examples thereof include aluminum, iron, copper, and stainless steel, and may be an alloy (for example, stainless steel or the like) obtained by combining two or more types of metals. The base member 2′ may have a multilayer structure in which a plurality of layers made of different materials are layered. The thickness of the base member 2′ is appropriately set depending on the use of the cooking tool 1, and is usually 1 mm or more and may be 10 mm or more. The thickness of the base member 2′ is usually 10 mm or less and may be 5 mm or less.

The coating film layer 4 is formed on the surface of the base member 2′, and the surface on which the coating film layer 4 is formed corresponds to the cooking region 2a. The coating film layer 4 has a structure in which a primer layer 41, an intermediate layer 42, and a topcoat layer 43 are layered in the mentioned order from the base member 2′ side. The coating film layer 4 has a thickness as uniform as possible however, there is no particular problem even when the thickness is slightly uneven.

The primer layer 41 is disposed on the surface of the base member 2′ and is made of a resin such as a fluorine-based resin, polyamide-imide, polyimide, polyether sulfone, polyether ether ketone, or polyphenyl sulfide. The fluorine-based resin is not particularly limited as long as the fluorine-based resin is a resin containing fluorine (F) in the molecule. Examples of such a fluorine-based resin include polytetrafluoroethylene (PTFE), tetrafluoroethylene-perfluoroalkyl vinyl ether copolymer (PFA), tetrafluoroethylene-hexafluoropropylene copolymer (FEP), polyvinylidene fluoride (PVDF), ethylene chlorotrifluoroethylene (ECTFE), and polypropylene fluoride (FLPP). These resins may be used alone or in a combination of two or more types of resins.

The thickness of the primer layer 41 is appropriately set depending on the use of the cooking tool 1, and is usually 5 μm or more and may be 10 μm or more. The thickness of the primer layer 41 is usually 30 μm or less and may be 20 μm or less.

The intermediate layer 42 is disposed on the surface of the primer layer 41, and is made of the aforementioned fluorine-based resin, or the fluorine-based resin and a resin such as polyamide-imide, polyimide, polyether sulfone, polyether ether ketone, or polyphenyl sulfide. The resin constituting the intermediate layer 42 may be the same as or different from the resin constituting the primer layer 41. In FIG. 2, the intermediate layer 42 has a single-layer structure. However, the intermediate layer 42 may have a multilayer structure depending on the use or the like of the cooking tool. When the intermediate layer 42 has a multilayer structure, the respective layers may be made of the same resin or may be made of different resins.

The thickness of the intermediate layer 42 is appropriately set depending on the use of the cooking tool 1, and is usually 10 μm or more and may be 15 μm or more. The thickness of the intermediate layer 42 is usually 30 μm or less and may be 20 μm or less. When the intermediate layer 42 has a multilayer structure, the thickness of the entirety of the intermediate layer 42 may be in the range described above.

The topcoat layer 43 is disposed on the surface of the intermediate layer 42, and is made of the aforementioned fluorine-based resin, or the fluorine-based resin and a resin such as polyamide-imide, polyimide, polyether sulfone, polyether ether ketone, or polyphenyl sulfide. The topcoat layer 43 corresponds to the cooking region 2a (cooking surface), and is preferably made of a fluorine-based resin in order to reduce adhesion and burning of food materials.

The thickness of the topcoat layer 43 is appropriately set depending on the use of the cooking tool 1, and is usually 10 μm or more and may be 20 μm or more. The thickness of the topcoat layer 43 is usually 50 μm or less and may be 30 μm or less.

Ceramic particles 5 having different shapes are contained while straddling the topcoat layer 43 and the intermediate layer 42. The material of the ceramic particles 5 is not particularly limited, and examples thereof include the ceramic particles 5 made of carbide ceramics such as silicon carbide, alumina (aluminum oxide), oxide ceramics such as silica (silicon oxide), nitride ceramics such as silicon nitride, and the like. The ceramic particles 5 may be used alone or in a combination of two or more types. Among these ceramics, ceramic particles primarily consisting of silicon carbide are preferably used in terms of thermal conductivity, hardness, affinity with organic coating materials, and the like. Note that the ceramic particles 5 may not only be located at the boundary between the topcoat layer 43 and the intermediate layer 42 but may also be contained in at least one selected from the group consisting of the topcoat layer 43, the primer layer 41, and the intermediate layer 42 other than the boundary. Silicon carbide has a thermal conductivity of 400 W/m·K or more and 500 W/m·K or less, and the coating film layer 4 provides improved thermal conductivity by containing the ceramic particles 5 primarily consisting of silicon carbide.

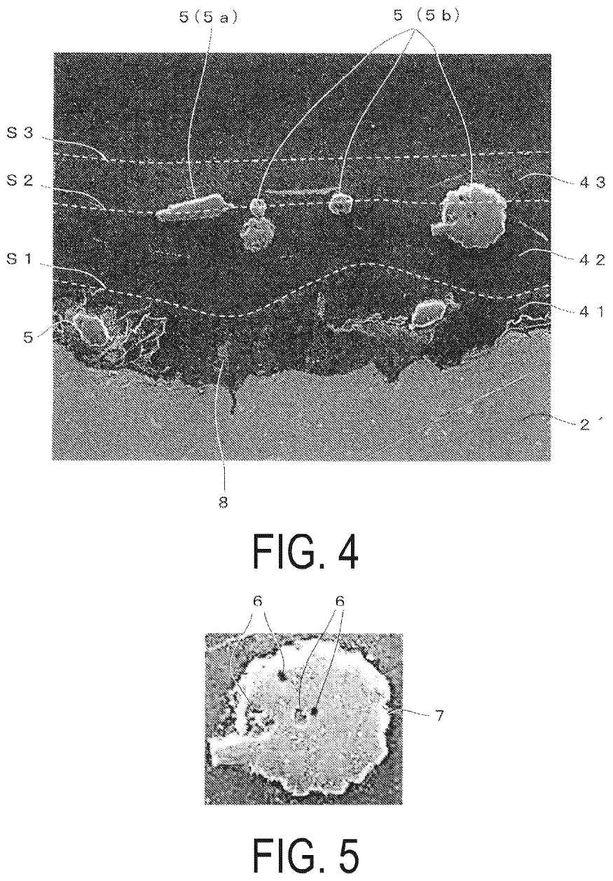

In particular, since the primer layer 41 is located on the surface of the base member 2′, and heat applied to the heating region 2b is transferred from the base member 2′ to the primer layer 41. Accordingly, the primer layer 41 can provide increased thermal conductivity by including the ceramic particles 5 therein. As a result, the thermal conductivity of the coating film layer 4 is increased, and the heat can be rapidly transferred from the heating region 2b to the cooking region 2a. In addition to the ceramic particles 5, diamond particles 8 may be contained in at least one selected from the group consisting of the topcoat layer 43, the intermediate layer 42 and the primer layer 41 (see FIG. 4), and thereby the thermal conductivity can be further increased. The thermal conductivity of the diamond particles 8 is 2000 W/m·K or more and 3320 W/m·K or less. When the diamond particles 8 are contained in all of the topcoat layer 43, the intermediate layer 42 and the primer layer 41, the thermal conductivity can be further increased.

At least some of the ceramic particles 5 may have an average particle diameter of 15 μm or more and 25 μm or less. The ceramic particles 5 may have an average particle diameter of 17 μm or more and 20 μm or less. The average particle diameter of the ceramic particles 5 may be measured, for example, by using a laser diffraction scattering method, a sedimentation method, or the like. Industrial (synthetic) diamonds or natural diamonds can be used for the diamond particles 8. The diamond particles 8 may have an average particle diameter of 5 μm or more and 30 μm or less. Particles having a smaller average particle diameter are preferably used for the diamond particles 8, and thereby dispersibility in the coating film layer 4 is improved. The average particle diameter of the diamond particles 8 may be measured, for example, by using a laser diffraction scattering method, a sedimentation method, or the like.

The shape of the ceramic particles 5 is not particularly limited, but is preferably a flat shape having a long diameter and a short diameter from the viewpoint of obtaining an anchor effect between the topcoat layer 43 and the intermediate layer 42. Other than the flat shape, the ceramic particles 5 may have a polished or molded shape such as a spherical shape, a granular shape, or a columnar shape, or may have an irregular shape such as fragments obtained by simply grinding ceramics. The ceramic particles 5 may be porous, or may have recessed and protruding portions on the particle surface and voids that are inside the particle and in communication with the particle surface. The use of porous ceramic particles 5 or the ceramic particles 5 having recessed and protruding portions and voids allows the resin forming the topcoat layer 43, the intermediate layer 42, or the primer layer 41 to enter the pores, the recessed and protruding portions, the voids, or the like of the ceramic particles 5. Accordingly, adhesion between the ceramic particles 5 and the topcoat layer 43, the intermediate layer 42, or the primer layer 41 is improved, thereby providing an anchor effect. The type such as the particle diameter and shape of the ceramic particles 5 affects the recessed and protruding shape and the surface roughness of the surface of the topcoat layer 43 (that is, the surface of the coating film layer 4). The type such as the particle diameter and shape of the ceramic particles 5 may be appropriately selected depending on the desired state of the coating film layer 4.

The contents of the ceramic particles 5 in the topcoat layer 43 and the intermediate layer 42 are not particularly limited. The ceramic particles 5 are be contained, for example, at a ratio of 3 parts by mass or more and may be contained at a ratio of 5 parts by mass or more to 100 parts by mass of the resin used in the topcoat layer 43 or to 100 parts by mass of the resin used in the intermediate layer 42. The ceramic particles 5 are contained, for example, at a ratio of 40 parts by mass or less and may be contained at a ratio of 30 parts by mass or less. The ceramic particles 5 are contained at a ratio of 1 part by mass or more and are preferably contained at a ratio of 10 parts by mass or less in view of the dispersibility of the coating material.

The content of the ceramic particles 5 in the primer layer 41 is not particularly limited. The ceramic particles 5 are contained, for example, at a ratio of 3 parts by mass or more and may be contained at a ratio of 5 parts by mass or more to 100 parts by mass of the resin used in the primer layer 41. The ceramic particles 5 are contained, for example, at a ratio of 40 parts by mass or less and may be contained at a ratio of 30 parts by mass or less. The ceramic particles 5 are contained at a ratio of 1 part by mass or more and are preferably contained at a ratio of 10 parts by mass or less in view of the dispersibility of the coating material.
The content of the diamond particles 8 in the topcoat layer 43, the intermediate layer 42, or the primer layer 41 is not particularly limited. The diamond particles 8 are contained, for example, at a ratio of 0.1 parts by mass or more and may be contained at a ratio of 10 parts by mass or less to 100 parts by mass of the resin used in the topcoat layer 43, the intermediate layer 42, or the primer layer 41.

FIG. 3 illustrates a scanning electron microscope (SEM) photograph (magnification factor: 430×) of a cross section of a cooking region which is a characteristic portion of one specific example of the cooking tool (frying pan) of the present disclosure. FIG. 4 is a part of the SEM photograph illustrated in FIG. 3, and is a drawing in which reference numerals are given to interfaces, members, and the like in order to facilitate understanding. FIG. 5 is an enlarged SEM photograph of one of the ceramic particles illustrated in the cross section in FIG. 3 and FIG. 4.

In FIG. 4, the primer layer 41, the intermediate layer 42, and the topcoat layer 43 constituting the coating film layer 4 are sequentially formed on the base member 2′. The primer layer 41 is made of a fluorine-based resin and a polyimide resin. The intermediate layer 42 and the topcoat layer 43 are both made of polytetrafluoroethylene (PTFE). An interface S1 is formed between the primer layer 41 and the intermediate layer 42, and an interface S2 is formed between the intermediate layer 42 and the topcoat layer 43. The interfaces S1 and S2 can be confirmed by observing an SEM photograph. The surface of the topcoat layer 43 is indicated by reference numeral S3.

A plurality of ceramic particles (specifically, silicon carbide particles) 5 are located across the intermediate layer 42 and the topcoat layer 43. The ceramic particles S include first ceramic particles 5a and second ceramic particles 5b having different shapes. The first ceramic particles 5a of the ceramic particles 5 are located on the left side in FIG. 4. The first ceramic particles 5a each have a flat shape having a long diameter and a short diameter in cross-sectional view, and a part of the surfaces elongated toward the long diameter side is in contact at an acute angle with the intermediate layer 42 and the topcoat layer 43 so as to dig into the intermediate layer 42 and the topcoat layer 43. Therefore, the bonding force between the topcoat layer 43 and the intermediate layer 42 is increased by the anchor effect. In cross-sectional view, the first ceramic particles 5a are preferably located such that the angle between the surface elongated toward the long diameter side and the interface S2 is within the range of larger than 0 degrees and smaller than 45 degrees. When the angle is 45 degrees or larger, the first ceramic particles 5 are in an upright state. Accordingly, leveling is reduced, and the first ceramic particles 5 are easily peeled off. Thus, wear resistance of the topcoat layer 43 is reduced. Note that the “upright state” refers to a state in which the surface elongated toward the long diameter side of the first ceramic particles 5 is located at an angle of 45 degrees to 90 degrees with respect to the surface of the topcoat layer 43 in cross-sectional view. When being in a standing state, the first ceramic particles 5 are easily exposed from the surface of the coating film layer 4. Accordingly, components (for example, salt) of a cooked portion enter from the exposed portion and permeate to the base member 2′, and the interface between the coating film layer 4 and the base member 2′ becomes easily peeled off. When the first ceramic particles 5a are located in the aforementioned angular range, leveling is increased, and the first ceramic particles 5a are not easily exposed from the topcoat layer 43, thereby improving surface smoothness. When the first ceramic particles 5a are located in the angular range of larger than 0 degrees and smaller than 30 degrees, leveling can be further improved.

FIG. 5 is an enlarged SEM photograph of one of the second ceramic particles 5b located on the right side of the ceramic particles 5 illustrated in the cross section in FIG. 4. As illustrated in FIG. 5, the ceramic particle 5b has a spherical shape having voids 6 on the surface and recessed and protruding portions 7 on the particle surface. The voids 6 are formed inside the second ceramic particle 5b in communication with the surface of the second ceramic particle 5b. In other words, the second ceramic particle 5b has recessed and protruding portions on the particle surface and the voids 6 inside in communication with the particle surface. As described above, when the second ceramic particles 5b are located across the topcoat layer 43 and the intermediate layer 42 and the surfaces of the second ceramic particles 5b have the recessed and protruding portions 7 and the voids 6, the bonding force between the topcoat layer 43 and the intermediate layer 42 is increased by the anchor effect. As illustrated in FIG. 4, the ceramic particles 5 having different shapes are located across the topcoat layer 43 and the intermediate layer 42. In other words, the first ceramic particles 5a each having a flat shape are located across the topcoat layer 43 and the intermediate layer 42, and the second ceramic particles 5b each having recessed and protruding portions and voids are located across the topcoat layer 43 and the intermediate layer 42. The anchor effect is increased, and thus bonding force between the topcoat layer 43 and the intermediate layer 42 is further increased. Therefore, peeling resistance of the topcoat layer 43 and the intermediate layer 42 is improved. The second ceramic particles 5b have low specific gravities due to the voids 6, and sedimentation of the particles is reduced in the topcoat layer 43 and the intermediate layer 42. Therefore, the second ceramic particles 5b are easily located between the topcoat layer 43 and the intermediate layer 42. The second ceramic particles 5b have low specific gravities and thus are not easily exposed from the surface of the topcoat layer 43. Therefore, the smoothness of the surface is improved.

As illustrated in FIG. 4, the diamond particles 8 and the ceramic particles 5 are located in the primer layer 41. The diamond particles 8 have a thermal conductivity higher than that of the ceramic particles 5 and are located in the primer layer 41, thereby improving the thermal conductivity of the primer layer 41. The diamond particles 8 have a hardness higher than that of the ceramic particles 5 and thus can further improve the wear resistance of the primer layer 41.

The diamond particles 8 can be contained in the coating material of the topcoat layer 43, the intermediate layer 42, or the primer layer 41, as necessary.

A method of forming the coating film layer 4 on the surface of the base member 2′is not particularly limited, and the coating film layer 4 is formed by a method usually adopted by those skilled in the art. For example, a method may be used in which resins forming the respective layers are dissolved or dispersed in solvents, applied to the cooking region 2a, and then dried. The applying method is not limited, and examples thereof include a spraying method, a brush coating method, and a dipping method. The drying method may be either natural drying or heat drying. The drying time is also not particularly limited. In the case of heat drying, for example, after drying at a temperature of about 70 to 150°° C. for a period of from about 5 to 30 minutes, firing may be further performed at a temperature of from about 380 to 400° C. for a period of from about 10 to 30 minutes, as necessary.

The coating film layer 4 is formed, for example, by the following procedures. First, a coating material containing a resin for forming the primer layer 41 and, if necessary, the ceramic particles 5 are applied to the surface of the base member 2′. After being applied, the coating material is dried and thereby the primer layer 41 is formed. Next, a coating material containing a resin for forming the intermediate layer 42 and, if necessary, the ceramic particles 5 are applied to the surface of the primer layer 41. Finally, a coating material containing a resin for forming the topcoat layer 43 and, if necessary, the ceramic particles 5 are applied to the surface of the intermediate layer 42.

In this case, in order to allow the ceramic particles 5 to be located across the topcoat layer 43 and the intermediate layer 42, after applying the coating material for forming the intermediate layer 42, the coating material for forming the topcoat layer 43 may be applied to the intermediate layer 42 in a non-dried state, that is, in a liquid or paste state, and the topcoat layer 43 and the intermediate layer 42 in the liquid or paste state may be dried. The coating materials forming the topcoat layer 43 and the intermediate layer 42 contain the first ceramic particles 5a and/or the second ceramic particles 5b. The ceramic particles 5 having a particle diameter smaller than the film thicknesses of the topcoat layer 43 and the intermediate layer 42 after drying are mixed in the coating materials forming the topcoat layer 43 and the intermediate layer 42 to be contained therein, and the topcoat layer 43 and the intermediate layer 42 in the liquid or paste state are dried. Thus, the ceramic particles 5 can be effectively located across the topcoat layer 43 and the intermediate layer 42.
When the primer layer 41 contains a large amount of the ceramic particles 5, the thermal conductivity of the primer layer 41 is improved. However, the ceramic particles 5 are connected to each other, and components (for example, salt) of a cooked food easily enter through a portion in which the particles are connected to each other. Since the components of the cooked food penetrate to the base member 2′ and dissolve the metal of the base member 2′, the coating film layer 4 is easily peeled off and corrosion resistance is easily reduced. Since the primer layer 41 contains the ceramic particles 5 and the diamond particles 8, thermal conductivity is improved and corrosion resistance is not easily reduced.

Each of the coating materials for forming the primer layer 41, the intermediate layer 42, and the topcoat layer 43 may contain a solvent as necessary in a resin component such as fluorine-based resin. The solvent is not particularly limited, and examples thereof include water, alcohols, ethylene glycol, N-methylpyrrolidone, glycol ethers, and hydrocarbon solvents. By using the solvent, the viscosity of the coating material can be adjusted, which makes it easier to apply the coating material.

Each of the coating materials described above may contain a binder as necessary in a resin component such as a fluorine-based resin. The binder is not particularly limited, and examples thereof include polyamide-imide, polyphenyl sulfide, polyether sulfone, polyimide, and polyether ether ketone. By using the binder, the ceramic particles 5 are easily fixed at the boundary between the intermediate layer 42 and the topcoat layer 43 and in each of the layers.

Each of the coating materials described above may be a clear coating material containing no pigment, or may contain a coloring pigment, a luster pigment, or the like. In the case of a clear coating material, a clear coating film is layered and thus a coating film with a design depth can be formed. A coloring pigment, a luster pigment, or the like is contained, and thus various decorations can be freely set.

The cooking tool of the present disclosure is not limited to the embodiment described above. For example, in the cooking tool 1 described above, the coating film layer 4 includes a three-laver structure in which the primer layer 41, the intermediate layer 42, and the topcoat layer 43 are layered. However, the coating film layer 4 is not limited to a three-layer structure, and may be a multilayer structure of four or more layers. Specifically, for example, the intermediate layer 42 may have a multilayer structure including two or more layers.

As described above in detail, the cooking tool 1 of the present embodiment achieves the following effects.

(1) The cooking tool 1 is configured such that the fluorine-based resin layer forms two layers of the topcoat layer and the intermediate layer, thus the thickness of the fluorine-based resin coating film layer is increased. Therefore, the wear resistance of the coating film is improved, corrosion resistance is excellent, and the life is extended.
(2) In the cooking tool 1, the ceramic particles are located across the topcoat layer and the intermediate layer that are fluorine-based resin layers, and thus the bonding force between the topcoat layer and the intermediate layer is increased, and the peeling resistance of the coating film layer is improved. As a result, the wear resistance of the coating film is further improved.

The cooking tool 1 according to the aforementioned embodiment is described by taking a frying pan as an example. However, the cooking tool of the present disclosure is not particularly limited to a frying pan as long as, for example, the cooking tool includes a metal material as a base material and is used for cooking various food materials with heating. Examples of such a cooking tool include, but are not particularly limited to, a hot plate, an octopus dumpling cooking plate, a plate for a heated steam cooker, an oven plate, a pot, a grill pot, a wok, and a kettle.

### REFERENCE SIGNS

1 Cooking tool (frying pan)
2 Body portion
21 Bottom portion
22 Side surface portion
2a Cooking region
2b Heating region
2′ Base member
3 Handle
4 Coating film layer
41 Primer layer
42 Intermediate layer
43 Topcoat layer
5 Ceramic particles
5a First ceramic particles
5b Second ceramic particles
6 Void
7 Recessed and protruding portions
8 Diamond particles
S1, S2 Interface
S3 Surface

1. A cooking tool comprising:
a base member comprising a cooking region on one surface; and
a coating film layer deposited on the one surface of the base member,
the coating film layer comprising a primer layer disposed on the base member side, a topcoat layer disposed on an outermost surface, and at least one intermediate layer disposed between the primer layer and the topcoat layer,
the topcoat layer and the at least one intermediate layer being made of fluorine-based resin, and
ceramic particles having different shapes being located across the topcoat layer and the at least one intermediate layer in a cross-sectional view.

2. The cooking tool according to claim 1, wherein
the ceramic particles contain first ceramic particles,
the first ceramic particles are each formed in a flat shape having a long diameter and a short diameter in cross-sectional view, and
a part of a surface elongated toward the long diameter side is in contact at an acute angle with the topcoat layer and the at least one intermediate layer.

3. The cooking tool according to claim 1, wherein
the ceramic particles contain second ceramic particles, and
the second ceramic particles each comprise recessed and protruding portions on a surface and voids inside in communication with the surface.

4. The cooking tool according to claim 1, wherein the primer layer contains the ceramic particles.

5. The cooking tool according to claim 1, wherein at least one selected from the group consisting of the topcoat layer, the intermediate layer, and the primer layer contains diamond particles.
